(19) United States
(12) Patent Application Publication
(10) Pub. No.: US 2024/0399731 A1
(43) Pub. Date: Dec. 5, 2024

(54) METHOD FOR PRODUCING A DECORATIVE ELEMENT, WHICH HAS A FUNCTIONAL OPENING, FOR A MOTOR VEHICLE, AND DECORATIVE ELEMENT

(71) Applicant: Lisa Dräxlmaier GmbH, Vilsbiburg (DE)

(72) Inventors: Christian SCHLEMMER, Landshut (DE); Linda PAINTNER, Landshut (DE); Wolfgang STRASSER, Aham (DE)

(73) Assignee: Lisa Dräxlmaier GmbH, Vilsbiburg (DE)

(21) Appl. No.: 18/806,357

(22) Filed: Aug. 15, 2024

Related U.S. Application Data
(63) Continuation of application No. PCT/EP2023/053010, filed on Feb. 7, 2023.

(30) Foreign Application Priority Data
Feb. 16, 2022 (DE) 10 2022 103 620.0

(51) Int. Cl. B32B 38/00; B32B 7/12; B32B 37/12; B60R 13/02

(52) U.S. Cl. CPC B32B 38/0004; B32B 7/12; B32B 37/12; B60R 13/02; B32B 2307/412; B32B 2307/414; B32B 2451/00; B32B 2605/003

(57) ABSTRACT

A method for the manufacturing of a decorative element, includes a functional opening, for a motor vehicle, as well as a decorative element. The method includes a decoration blank that includes a visible side and an adhesive side, and an application material layer that includes an adhesive side and a lamination side. The decoration blank is cut through along a functional opening contour by a cutting element of a cutting machine, and a waste piece is removed, forming the functional opening. The application material layer is applied onto the decoration blank by the adhesive side of the application material layer and the adhesive side of the decoration blank is adhered with each other by an adhesive layer. The functional opening is filled with a filler material that reacts into a cured state, wherein it is at least partially translucent, at least partially transparent, completely transparent, or light-impermeable.

### CROSS-REFERENCE TO RELATED APPLICATIONS

This application is a continuation of International Application No. PCT/EP2023/053010, filed on Feb. 7, 2023, which claims priority to and the benefit of DE 10 2022 103 620.0 filed on Feb. 16, 2022. The disclosure of each of the above referenced applications is incorporated herein by reference.

### FIELD

The present disclosure relates to a method for the manufacturing of a decorative element that includes one or more functional openings.

### BACKGROUND

The statements in this section merely provide background information related to the present disclosure and may not constitute prior art.

From DE 10 2019 135 217 A1 a visible-/interior-component for the interior of a vehicle is known that includes a surface element, that has a top side and a bottom side, and is at least partially transparent in a visible spectral range. The visible-/interior-component further includes an illumination unit, using which the surface element is through-lightable with light up from the bottom side.

Nowadays soft or flexible or pliable decorative elements that include one opening or more openings, and consequently one delicate bridge or more delicate bridges can only be aligned with one another and laminated on a carrier structure with the use of particularly great effort so that a high lamination quality results. Because conventional decorative elements, or decorative elements that have been/are manufactured using conventional methods tend to form wrinkles or a warping of the decorative element during the laminating-on onto a carrier structure, in particular in the region of the corresponding functional opening or in the region of the bridges between the functional openings, above all when these bridges are particularly delicate. Furthermore, the aligning of two decorative elements over a gap or directly adjacent to each other is particularly laborious, since a consistently high repeat quality is difficult. Therefore particularly complex, detail-rich patterns that should be shown on the decorative element using the openings are often omitted. Furthermore, to date the applying of the decorative element on the carrier structure uses a time-intensive positioning and fixing of the decorative element, or plurality of such decorative elements, that is pliable or flexible and partially opened by the opening or openings. However, this is inefficient, and in serial production leads to undesirably long dwell times for the laminating-on of the decorative element onto the carrier structure. These issues are not solved by the conventional visible-/interior-component.

### SUMMARY

This section provides a general summary of the disclosure and is not a comprehensive disclosure of its full scope or all of its features.

The present disclosure provides a decorative element with at least one particularly detailed functional opening, which is laminatable-on onto a carrier component particularly easily and with high lamination quality, and is particularly stable or long-lasting. A decorative element is provided in particular for a use in the automotive sector, for example, as decorative element in an interior of a motor vehicle, in particular an automobile and/or truck. Possible applications of such a decorative element are, for example—in particular illuminated/illuminable or backlit/backlightable—symbols (warning symbols, state indicators, etc.), emblems (crests, manufacturer symbols, logos, vehicle-model- and/or model-range-names, etc.), functional decorations (interior- an/or ambient-lighting, button- and/or switch-surfaces, etc.), seams, seam imitations (for example, decorative seams, functional seams, cross seams, etc.). In addition, the present disclosure relates to such a decorative element that is manufactured using the method.

According to the present disclosure a method is proposed for the manufacturing of at least one decorative element, in which the decorative element includes one functional opening or more functional openings. Here the respective functional opening can be, for example, a light- or illumination-opening and/or function as a flow-permeable or sound-permeable opening (for example, sound opening). Such a light opening as well as such a flow-permeable or sound-permeable opening shall be described in more detail below. The decorative element is provided for a motor vehicle, for example, for an automobile, in particular for an interior of the motor vehicle. The method is used for the manufacturing. In other words, the decorative element is a product that has been/is manufactured using the method. The method for the manufacturing of the decorative element includes the steps explained in more detail below, which can take place in a different order deviating from the order in the description. Furthermore, the steps can at least partially temporally overlap or at least partially take place simultaneously. In other words: First the individual steps that the method includes are shown; their order arises in connection with the description of the possible designs. The order of the steps possibly overlaps from possible design to possible design. In this respect the ordinal numbers used in the description for the steps do not necessarily indicate a sequence of the steps, but rather primarily offer a structured description.

In a further step of the method, first the decoration blank and an application material layer are provided. The decoration blank can be configured pliable, rigid, or reversibly elastically flexible. In addition, the decoration blank can already include openings, a perforation, etc. before its processing using the method described herein. The decoration blank has a visible side and an adhesive side (which can also be referred to as finishing side), in which these two sides are spaced from each other by a material thickness of the decoration blank, and their surface normals oppose each other. The decoration blank is in particular a flat product made of a textile or a textile-type material, of leather, and/or artificial leather. Furthermore, film structures or rigid structures (for example, plates) made of these or other materials are conceivable, for example, made of TPO (thermoplastic polyolefin) etc. Natural, renewable, and/or synthetic leather replacement materials (apple leather, mushroom leather, eucalyptus leather, pineapple leather, etc.), hot-stamped or non-hot-stamped textiles, glass, or limitation glass, metallic materials, ceramics, wood, plastics, etc. are possible as material for the decoration blank. A material structure made of a mixed material is also conceivable, which includes, for example, one or more of the materials mentioned. If two or more decoration blanks are used, they can be made of the same or of different materials. The respective material can be transparent or non-transparent and/or permeable or impermeable for acoustic waves.

The application material layer can be configured pliable, rigid, or reversibly elastically flexible, and has an adhesive side and a lamination side that are spaced from each other by a material thickness and whose surface normals oppose each other. In particular the application layer is a textile structure, a fabric, a knitted fabric, in particular knitted spacer fabric, a crocheted fabric, a mesh, a stitch-bonded fabric, a fleece, a film. The application material layer can be permeable for light, at least for such light that has a wavelength from approximately 380 nm (nanometers) to approximately 780 nm and is therefore visible for a person with physiological eyes without further aid. In other words, the application material layer is permeable for visible light. For example, the light can filter-through through meshes or other material-free spaces of the application material layer. Furthermore, it can be provided that the light filters-through directly through a material—i.e., for example, directly through threads—of the application material layer, wherein then the application material layer is manufactured from an at least partially translucent or transparent, in particular transparent material offering image fidelity. Alternatively or additionally the application material layer can be coated at least regionally, for example, with an application of paint, such that it is light-permeable or lightproof at the coated locations. In addition, a color appearance of the application material layer can be adapted according to need using the application of paint.

The method includes in particular a further step in which the decoration blank is fixed in a cutting machine such that a processing of the decoration blank can be affected using the cutting machine. The decoration blank is thus positioned in a processing region of the cutting machine, and, for example, clamped, mounted, adhered (for example, using an adhesive tape), sucked using a vacuum generator onto a cutting bed or onto a cutting table of the cutting machine, etc. The decoration blank can be fixed in the processing region of the cutting machine with or without preload. In this state it is made possible that a cutting element of the cutting machine penetrates or cuts-in into a material body of the decoration blank, whereby the decoration blank is processed by the cutting machine or its cutting element. The cutting machine is in particular a computer-controlled cutting machine, for example, a CNC cutting machine. A laser cutting machine, in particular with a CO2 laser generator, can be provided as cutting machine. Accordingly the cutting element of the cutting machine can be, for example, a laser beam. As CNC laser cutting machine, the laser cutting machine includes a device for the electronic or computer-controlled rail-guided laser cutting. For this purpose the laser beam can be guided using a robot system. Furthermore, a fixed laser field is conceivable in conjunction with a laser scanner or a laser mirror device for directing the laser beam. The laser scanner can alternatively or additionally be moved using the robot system or a different robot system.

In any case, in a further step of the method the decoration blank is processed using the cutting machine. For this purpose the decoration blank is cut into using the cutting machine. The decoration blank is cut into and in particular completely cut-through using the cutting machine, that is, by its cutting element, along a prescribed or prescribable functional opening contour. Here the decoration blank can first be cut into along the functional opening contour and then cut-through along the functional opening contour; in other words a multi-step cutting process or laser process can be used in order to completely cut-through the decoration blank. Due to the cutting-through of the decoration blank a waste piece results that includes at least one decoration material portion. After the cutting-through of the decoration blank, the waste piece is removed out of/from the decoration blank, whereby a functional opening is formed or exposed. The waste piece can be removed via the visible side or via the adhesive side of the decoration blank.

In a further step of the method-prior to the cutting-through of the decoration blank using the cutting machine—the application material layer is applied onto the decoration blank or attached thereto by the adhesive side of the application material layer and the adhesive side of the decoration blank being adhered with each other—at least temporarily and/or only in the cutting region-using an adhesive. This means that in addition to the decoration blank, the application material layer, and a possible cutting-aid layer, the adhesive layer or an adhesive is provided (for example, during the providing of the decoration blank or of the cutting-aid layer or in a further step of the method) that forms the adhesive layer between the decoration blank and the application material layer during the connecting of the decoration blank with the application material layer. The decoration blank and the application material layer are thus connected with each other in a material-bonded manner. The connecting of the application material layer with the decoration blank is in particular effected after the functional opening(s) has/have been produced using the cutting machine.

The cutting-in into the decoration blank using the cutting machine can thus on the one hand be affected when the application material layer and the decoration blank are not yet connected with each other. In other words, it is a possibility to first process the decoration blank using the cutting machine, in particular to cut out the waste piece from the decoration blank, when a composite made of the application material layer and the decoration blank has not (yet) been formed. In this case the application material layer is only connected with the decoration blank afterwards.

Alternatively the decoration blank can be cut into using the cutting machine when the decoration blank and the application material layer are already connected with each other. In other words, it is a further/different possibility to only process the decoration blank using the cutting machine when the composite is formed from the application material layer and the decoration blank. The waste piece (which in this case includes application material and decoration material) is thus cut out from the composite. For example, the decoration blank is cut into by the application material layer being cut-through using the cutting machine. This can be affected in a multi-step cutting process.

The material of the decoration blank can have an uneven topography on the adhesive side, for example, with peaks and valleys. Here the applying or spreading of the adhesive can be intentionally controlled such that only peaks are coated with the adhesive. Alternatively the applying of the adhesive can be controlled such that both the peaks and the valleys are coated with the adhesive. In the case of a porous material of the decoration blank, the adhesive can at least partially diffuse into or be absorbed into the material. A laminating adhesive can be used in particular as adhesive, using which the completed decorative element is laminated onto the carrier structure.

For the cutting-through of the decoration blank using the cutting machine, the application material layer is cut-through, provided it has been connected with the decoration blank prior to the cutting process (see description for the third method step). In this case the waste piece can include a corresponding portion of the application material layer.

The first functional opening is partially or completely filled with a filler material (for example, a polymer, a hotmelt, a dispersion, etc.). If the first functional opening is configured as a light opening (which can also be referred to as illumination opening or backlighting opening)—before, during, or after the applying of the application material layer onto the decoration blank—the first functional opening is filled with the filler material. In the fully cured state the filler material is, for example, translucent, that is, permeable for visible light. Thus a light opening is formed from the first functional opening by it being filled with the filler material that reacts into a cured or hardened state in which it is at least partially translucent or at least partially transparent, in particular transparent with image fidelity. Here the filler material can have, for example, a milky appearance, similar to frosted glass. It is furthermore conceivable that by the curing the filler material forms, at least on the visible side, a light-diffusing surface structure. With a through-lighting of the filler material a diffusely distributed light thereby arises in a desired manner, which light exits from the filler material. Alternatively it is conceivable that in the cured state the filler material is completely transparent, in particular transparent with image fidelity.

If the first functional opening is configured as a flow-permeable or sound-permeable opening, for example, as a sound opening, it is filled with the filler material at most partially with the filler material. In this case the filler material can be selected such that it reacts into the fully cured state by the filler material being non-light-transparent or lightproof. Thus a flow-permeable or sound-permeable opening is formed from the first functional opening by it being filled at most partially with the filler material that reacts into a fully cured or hardened state in which it is non-light-transparent or lightproof.

In any case it can be provided that the filler material is pliant, rigid, or reversibly elastically flexible, and before the inserting into the functional opening, has been brought, using chipless or chipping production methods, into a shape that corresponds to the shape of the functional opening. Furthermore it is conceivable that the filling material is brought into a liquid or at least pasty state and then inserted into the functional opening in order to cure inside the functional opening. The filler material can furthermore serve as a coating material for the coating of the lamination side of the application material layer. For the filling, the filler material can be rolled-on on the lamination side of the application material layer, for example, using a transfer roller device. Here on the one hand the functional opening is filled with the filler material since it runs into the functional opening in particular when the filler material is applied in liquid/paste onto the lamination side. On the other hand the lamination side of the application material layer is coated with the filler material by the rolling-on of the filler material, even away from the functional opening.

In general, the filler material can at least have adhesive properties of an adhesive, or be an adhesive. Accordingly the filler material can further be used to generate a final adhesion between the application material layer and the decoration blank.

It is furthermore conceivable that a pre-adhesive is first applied between the decoration blank and the application material layer, which pre-adhesive is configured less strongly adhering in comparison with the final adhesive. For example, the decoration blank and the application material layer can initially be fixed against each other by the first component of a two-component adhesive. In this way the waste piece can be particularly easily removed, in particular together with a portion of the first adhesive component adhering to the waste piece. Here a corresponding tempering of the waste piece to be removed and/or of the adhesive component portion adhering thereto can facilitate the easy removal. For the final adhering a further adhesive or a second component of the two-component adhesive is brought between the decoration blank and the application material layer, for example, by the second adhesive component or the further adhesive penetrating it from the lamination side of the application material layer. Such a process is described further below in connection with the filler material. In addition it can be provided that further adhesive or the second adhesive component flows-in into one or more functional openings. Accordingly the second adhesive component or the further adhesive can be the filler material or a component of the filler material.

Alternatively or additionally the waste piece can be particularly easily or more easily removed by it (with or without the portion of the adhesive adhering thereto) being removed before a final solidifying of the adhesive, that is, for example, before the adhesive is completely cured.

In addition, the adhesive side of the decoration blank can be coated with a polymer before the applying of the adhesive onto the decoration blank or before a bringing-into-connection with the adhesive applied onto the application material layer. This brings the advantage that, for example, a fiber tear in the functional opening during the removing of the waste piece is inhibited or at least reduced. Furthermore, due to the polymer coating an interference-free filling of the functional opening with the filler material is supported so that in the finished decorative element an unobstructed light emission is provided.

After the decorative element has been manufactured according to the above method, or one or more of the examples described in the following, one further opening or more further openings can be formed in the decorative element, which can function, for example, as acoustic opening and/or as ventilation opening.

Using this method, the decorative element can on the one hand be particularly efficiently manufactured. On the other hand, the decorative element manufactured using the method is particularly lamination-friendly and consequently can be laminated-on onto the carrier structure particularly precisely, in particular without warpage and without wrinkling. The carrier structure is in particular an injection-molded carrier, which is coated with a layer made of a soft component (for example, a textile, a spacer fabric, a foam, etc., wherein it is not the application material layer) or at least partially comprised thereof. On this layer the decorative element can be particularly simply laminated-on by soft lamination. Alternatively the carrier structure can be configured dimensionally stable or at least have a dimensionally stable surface. On the dimensionally stable carrier structure the decorative element can be particularly easily laminated-on using hard lamination—that is, without the layer made of the soft component.

Since the decoration blank is stabilized by the application material layer during the laminating, so that the functional openings and bridges-even when these are particularly delicate, approximately only a few millimeters or less then one millimeter wide-possibly present between the functional openings do not deform in an undesired manner. A particularly high lamination quality results that in an advantageous manner can be held at a constantly high level within a production series. A time-intensive positioning of the decorative element on the carrier structure and rectifying of undesired deformations/wrinkles during the laminating-on of the decorative element can be advantageously omitted. Complex or elaborate designs are thus possible that can be produced inexpensively. Due to the mechanical (in particular computer-controlled) cutting using the cutting machine, furthermore a particularly high reproduction precision results, and thereby less waste, which leads to a particularly resource-saving manufacturing of the decorative element.

In a further example of the method a composite is produced from the decoration blank and a cutting-aid layer by the cutting-aid layer—for example, using an assistive adhesive layer—is adhered onto the visible side of the decoration blank. The cutting aid layer can furthermore be a protective-coating layer, so that for the applying of the cutting-aid layer the visible side of the decoration blank is coated, for example, sprayed, with the protective coating. Furthermore, as cutting-aid layer a film is conceivable that is placed-on onto the visible side of the decoration blank. The assistive adhesive layer can be configured as a component of the cutting-aid layer.

This means that in addition to the decoration blank and the application material layer, the cutting-aid layer is provided (for example, in the first step or in another step of the method). In the producing of the composite, the decoration blank and the cutting-aid layer are thus connected with each other in a material-bonded manner. Here the decoration blank and/or the cutting-aid layer and/or the assistive adhesive layer are configured such that the material-bonded connection between the decoration blank and the cutting-aid layer is releasable without the visible side of the decoration blank being damaged during the releasing of the cutting-aid layer. In other words: the cutting-aid layer that has been adhered to the visible side is non-destructively releasable from the visible side. The cutting-aid layer is in particular a film.

Before the cutting-through of the decoration blank, in particular before the fixing of the decoration blank in the cutting machine, the cutting-aid layer is adhered with the decoration blank. This means that the steps that up to now relate only to the decoration blank, analogously apply to the composite including the decoration blank and the cutting-aid layer. Thus, for example, the composite that is formed from the decoration blank and the cutting-aid layer is fixed in the processing region of the cutting machine. During the cutting through of the decoration blank, the cutting element, for example, impinges on the adhesive side of the decoration blank connected with the cutting-aid layer in the composite, and cuts-through it completely. Here the cutting-aid layer adhered onto the visible side of the decoration blank can be incised and/or completely cut-through by the cutting element.

Due to the cutting-aid layer adhered onto the visible side, the visible side is protected from mechanical damage during the positioning and fixing in the processing region of the cutting machine.

In a further example of the method, the cutting-through of the decoration blank or the processing of the composite is affected by laser cutting, that is, using a laser-cutting machine. Accordingly the cutting element is a laser beam. During the processing of the composite including the decoration blank and the cutting-aid layer, or of the decoration blank alone, using the laser-cutting machine, only the decoration blank may be cut into or cut-through. Furthermore it is conceivable that under the cutting of the composite using the laser cutting machine, further layers of the composite are cut into or cut-through, for example, the cutting-aid layer. If the cutting or a further cutting is affected when the application material layer and the decoration blank are already adhered with each other, it can be provided that using the cutting machine, in particular laser-cutting machine, the adhesive layer and/or the application material layer are/is cut-through. In any case, the laser cutting can occur single-step or multi-step.

Due to the mechanical laser cutting using the laser-cutting machine, the idea of a particularly high reproduction accuracy and consequently of a particularly resource-saving producing of the decorative element is especially taken into account. Furthermore, particularly delicate designs or patterns can be created, especially those where an inner pattern segment of the decoration blank is surrounded by a material recess, and an outer pattern segment made of the material of the decoration blank adjoins the material recess. By this pattern being directly cut using the laser-cutting machine, in which the composite is constructed in a sandwich-type manner, an always identical positional location of the internal pattern segment is provided from decorative element to decorative element. In comparison to another cutting- or stamping-method for the forming of an opening in a decoration blank, the laser cutting has still further advantages: Thus, the decoration blank is not subjected to mechanical stresses that occur during mechanical cutting or stamping due to a blade or punching body being driven through the decoration blank. The decoration blank is thereby not deformed to an undesired degree. In particular during stamping, material displacement occurs, and as the wear of the stamping body increases, this material displacement and consequently the unwanted deformation increases; the openings created by stamping become larger than expected, their edges become more cracked, and their geometry becomes less precise.

In the method in a further development, it is provided that the cutting element for processing the decoration blank, strikes its adhesive side and cuts-in toward the visible side of the decoration blank, wherein the decoration blank is completely cut-through. By cutting into the adhesive side of the decoration blank to create the decorative element in particular when using laser cutting a particularly high edge quality is achieved along the contour of the functional opening. Furthermore, the visible side of the decoration blank can be protected during the cutting, in particular laser cutting, by the cutting-aid layer applied thereon. Since as already presented above the decoration blank and the application material layer can already be connected with each other before the cutting-through of the decoration blank, the cutting element, in particular the laser cutting-beam, penetrates the application material layer, in this case for the cutting-through of the decoration blank.

According to a further example of the method, a particularly accurately cut edge of the functional opening results along its functional opening contour when the cutting element impinges against the adhesive side of the decoration blank at least in a first functional opening contour segment or along the entire functional opening contour parallel to a surface normal of the visible side. The surface normal is a (imaginary, mathematical-geometric) vector that extends perpendicular to the adhesive side. In other words, the cutting element, for example, the laser beam, impinges perpendicularly against the adhesive side of the decoration blank at least along the first functional opening section, and thus cuts in perpendicularly into the decoration blank and optionally in further layers of the composite.

A particularly broadly varied diversity of possible designs of the functional openings results when as a further example of the method provides at least in a second functional opening contour section or along the entire functional opening contour, the cutting element impinges against the adhesive side of the decoration blank obliquely to the surface normal of the adhesive side. In other words, at least along the second functional opening section the cutting element, for example, the laser beam, impinges obliquely against the adhesive side of the decoration blank and thus cuts into the decoration blank, and possibly into further layers of the composite, obliquely. In this way, for example, functional openings can be generated that on the part of the visible side of the decoration blank have an opening surface that is larger than on the part of the adhesive side of the decoration blank or decorative element. If such a functional opening functions as a light opening, the filler material can then serve as a light-collecting element or prism element. In this case light effects/light colors can mix in a particularly versatile manner in order to make possible a desired lighting out from the functional or light opening.

According to a further example of the method, a further (second) functional opening can be generated, which forms a flow-permeable or sound-permeable opening, by cutting-through using the cutting element along a second prescribed or prescribable functional opening contour of the decoration blank, and the waste piece thereby arising being removed. This includes-if the cutting through of the decorative element is affected without the application material layer adhered thereon—the corresponding portion of the decoration material. If the cutting-through of the decorative element is affected with the application material layer adhered thereon, the waste piece further includes the corresponding portion of the application material layer. Here during filling of the other functional opening, functioning as light opening, with the filling material the second functional opening, i.e., the flow-permeable or sound-permeable opening, is filled at most partially with the filler material. In other words: the opening was not at all or at most partially filled with the filler material, or the opening remains at least partially spared from a filling with the filler material. That is, during the manufacturing of the decorative element the flow-permeable or sound-permeable opening is partly or completely kept free of the filler material. It can be provided that the flow-permeable or sound-permeable opening is first filled with the filler material, and then at least a part of the filler material initially filling the opening, or the filler material is completely removed again from the opening, so that it is flow-permeable or sound-permeable. This can be affected, for example, using the cutting machine and/or another tool by filler material filling the opening being cut-into, drilled into, etc. If the decorative element has the flow-permeable or sound-permeable opening configured, for example, as sound opening, it can advantageously serve as cover for a loudspeaker of the motor vehicle, since sound waves that are generated by the loudspeaker can pass particularly efficiently through the sound opening into the interior of the motor vehicle. Thus the decorative element can serve as separating element between the interior and an installation space of the loudspeaker so that without functional limitation the loudspeaker already cannot be seen or discerned by an occupant of the motor vehicle. It can furthermore be provided that the first functional opening is configured as flow-permeable or sound-permeable opening and/or that the decorative element generally only includes a single functional opening that is configured as sound opening or as light opening. Furthermore, the decorative element can include both at least one functional opening functioning as light opening and at least one functional opening functioning as sound opening. In addition the decorative element can comprise only sound openings or only light openings. The decorative element is manufacturable by the method described herein in a particularly efficient and needs based manner with the corresponding functional opening or with the corresponding functional openings.

For the cutting, in a further example of the method a cutting depth is prescribed such that the cutting element specifically completely cuts-through the decoration blank, but the cutting-aid layer is not completely cut-through, that is, is at most cut-into. In particular, using the cutting element or using the laser beam, only the decoration blank can be cut-through along the entire functional opening contour, but the cutting-aid layer is not completely cut-through. In this case the waste piece includes only the decoration material portion, so that with the removal/pulling-off of the waste piece from the composite, only decoration material is removed and the cutting-aid layer and possibly the assistive adhesive layer remain/remains. Alternatively thereto, it is conceivable that the assistive adhesive layer has been configured such that in the region of the functional opening it is removed from the composite together with the decoration material portion of the waste piece. Furthermore in this case it can be (but need not be) provided in this case—when only the decoration blank is to be cut-through along the entire functional opening contour—that a further cutting of further layers of the composite is omitted. A particularly stable decorative element and a particularly stable functional opening, in particular light opening, result. Then as soon as the decoration blank is adhered with the application material layer, it is supported or held by the application material layer. The through-lighting of the light opening is then affected by the light-transparent application material layer and—if adhesive of the adhesive layer is on the application material layer-through the adhesive layer. Because in general with the method it is provided in particular that the adhesive used, which forms the adhesive layer, is permeable for visible light at least in the cured state, that is, translucent, or transparent, in particular transparent with image fidelity.

According to a further example of the method, the decoration blank can be provided by it being formed from at least two mutually separate decoration blank parts. Here the two decoration blank parts are adhered together, and with formation of at least one edge opening or edge gap between them, initially-before or after a cutting operation using the cutting machine—with the application material layer. Thus the decoration blank parts are held together, or positionally fixed relative to each other, by the adhesive connection between them and the application material layer. It can further be provided that before the fixing in the processing region of the cutting machine, the decoration blank parts are connected with the cutting-aid layer, in particular before the application material layer and the decoration blank parts are connected with each other. The cutting-aid layer can thus function as a positioning aid in order to introduce the decoration blank parts with each other into the processing region and to fix them there. In addition, a relative position of the decoration blank parts can be provided by the cutting-aid layer for the cutting of the decoration blank and/or in order to apply the application material layer onto the decoration blank parts.

Due to the edge opening, a further (for example, third) functional opening is formed that is filled with the filler material. Alternatively a further (for example, second) sound opening is formed by the edge opening or the third functional opening, which—as presented further above—is filled at most partially with the filler material during filling of the light opening or light openings. This means the respective edge opening can function in its entirety either as a light opening or as a sound opening. Furthermore, it is conceivable that both a light opening and a sound opening are formed by the edge opening by the edge opening being filled in or filled with the filler material only partially, or the filler material being only partially removed from the edge opening. In addition, a first edge opening and a second edge opening or more edge openings can be formed, for example, when more than two decoration blank parts for the decoration blank are connected on the application material layer. Then, for example, two edge openings are formed, of which one can function as the light opening, and the corresponding other can function as sound opening. With two more edge openings, one or both of the edge openings can function partially or completely as light opening, and partially or completely as sound opening. Due to the providing of the decoration blank comprised of a plurality of individual parts, a still greater diversity of design- and use-possibilities is given for the functional openings or for the decorative element.

In a further development of the method, the cutting-aid layer is non-destructively released from the visible side of the decoration blank, whereby the waste piece arising due to the cutting and adhered with the cutting-aid layer is removed. This means that at least in the region of the cut functional opening, the cutting-aid layer has been adhered strongly or stably enough with the decoration blank that with non-destructive releasing of the cutting-aid layer, the waste piece is also removed from the composite. Here the removing or the releasing of the cutting-aid layer is affected in particular after the adhering of the decoration blank with the application material layer. Then the composite is thus already stabilized by the application material layer, so that during the releasing of the cutting-aid layer from the visible side of the decoration blank, no wrinkles form, nor is the decoration blank otherwise deformed in an undesired manner.

In a further example of the method, at least one narrow channel element is formed on the adhesive side of the decoration blank by—for example, using the cutting machine, or laser-cutting machine, or another ablation tool (mill, cleavage tool, etc.)—material of the decoration blank being removed from the adhesive side of the decoration blank, without damaging the visible side here. During the forming of the respective channel element, two or more of the following elements of the decoration blank are fluidically connected with each other: the functional opening optionally configured as edge opening, one or more of further functional openings, for example, further light-, sound-, and/or edge-openings, etc.

During the filling of the functional opening with the filler material, the channel element is thereby filled with the filler material, whereby the at least two elements of the decoration blank fluidically connected by the channel element are connected with each other in a material-bonded manner by the filler material. Because generally it can be provided with the method or with the decorative element that the filler material has at least adhesive properties of an adhesive. Accordingly, for example, an adhesive can be used as the filler material. Due to the channel element that is filled with the filler material, a bridge made of the filler material thus arises between the two elements of the decoration blank that are fluidically connected with each other via the corresponding channel element. Thus a particularly strong or stable connection results between the elements filled in with the filler material, and consequently a particularly stable decorative element. Furthermore, it is provided that with a laminating-on of the completed decorative element, the filler material remains securely in place in a desired manner and does not come loose from the decoration blank.

If it should occur that during the forming of the channel element the visible side of the decoration blank is damaged, for example, scratched or partially cut into, the filler material intentionally functions as a fill material, using which the incision or the scratch is filled in and stabilized.

For the filling of the cut functional opening with the filler material, in a further example of the method it is provided to provide the filler material for the filling of the light opening in an at least pasty, in particular liquid state, so that during the filling or upon the filling of the light opening a material-bonded connection is produced between the decoration blank and the filler material. Due to the adhesive, that is, material-bonded connection between the filler material and the decoration blank—and in particular between the filler material and/or the application material layer—a particularly stable structure results of the decorative element, in particular when the filler material has adhesive properties.

In a further example of the method, the adhesive layer and the application material layer are provided fluid-permeable, and the filler material is introduced from the lamination side of the application material layer into the corresponding functional opening by the application material layer and the adhesive layer being supersaturated with the filler material, so that first the application material layer and then the adhesive layer are flowed-through with the filler material toward the visible side of the decoration blank, whereby upon an exiting from the adhesive layer the filler material flows into the functional opening. If, on the other hand, the adhesive layer was previously also removed or omitted in the region of the functional opening, it is conceivable to form or provide only the application material layer as fluid-permeable. It then applies in this case that the application material layer is provided fluid-permeable, and the filler material is introduced from the lamination side of the application material layer into the corresponding functional opening by the application material layer being supersaturated with the filler material, so that the application material layer is flowed-through by the filler material toward the visible side of the decoration blank, whereby the filler material flows-in into the functional opening upon an exiting out of the application material layer. If a plurality of functional openings are provided, the filling of these functional openings can also be effected by the filling material being brought into contact with the lamination side of the application material layer only in the region of some or only in the region of a single one of these functional openings. With a saturation and a subsequent supersaturation of the application material layer with the filler material, the filler material is distributed in the application material layer and thereby flows-due to the porous or fluid-permeable structure of the application material layer—to the other of the functional openings and into the other functional openings. Thus a large-surface application of filler material can be omitted.

In any case enough fluid/pasty filler material is brought into direct contact with the lamination side of the application material layer that the application material layer and possibly the adhesive layer is or are saturated with the filler material, and subsequently at least in the region of the functional opening is or are completely soaked, which causes that the filler material flows in through the application material layer and possibly through the adhesive layer into the functional opening. At the latest after the flowing-in into the functional opening, the filler material cures, for example, passively or by addition of an activator or curing agent, of heat or other radiation, for example, ultraviolet light, etc. In the cured state the filler material is, for example, hardened and in any case translucent. In this case “hardened” does not necessarily mean that the filler material is rigid or brittle in the cured state, rather “hardened” is to be understood herein to mean that under normal conditions no further relevant solidity increase is to be expected. Accordingly the filler material can be flexible in this completely hardened state. In particular, the filler material is selected such that with respect to bendability, stability, etc. it corresponds to a bendability or stability of the decoration material.

On the one hand a particularly stable decorative element thereby results, and on the other hand with the method it is associated with particularly little effort to fill in the functional opening with the filler material. Because a cutting of the application material layer can be omitted, whereby an entire cutting process for the forming of the functional opening is shown to be particularly short. Particularly short dwell times can be maintained with the use of the cutting machine, which is particularly favorable. As already presented above, the application material layer can namely be connected with the decoration blank also after the cutting-through of the decoration blank.

If the application material layer adhered with the adhesive side of the decoration blank and the adhesive layer are cut-through by a further cutting, or if the application material layer as well as the adhesive layer are provided with corresponding openings in the region of the functional openings to be filled, an alternative approach for the filling of the functional openings with the filler material comes into consideration: in this case the filler material is introduced into the functional opening or light opening through the adhesive-layer openings or the application-material-layer openings. In this way a particularly efficient filling of the functional opening is provided.

According to a further possible example of the method, for the filling of the light opening with the filler material, the visible side of the decoration blank including the light opening and a seal element can be fixed against each other such that the light opening is fluid-sealed by the seal element on the visible side against an exiting of filler material onto the visible side. It is thus provided that no filler material reaches the visible side of the decoration blank, which would have to be removed again after the filling. The method thus delivers a particularly clean decorative element that can be laminated onto the carrier structure as intended without a cleaning step beforehand. This again contributes to a particularly efficient manufacturing method.

Optionally in general with the method, at least the region of the composite or of the decorative element can be subsequently pressed or subsequently sintered in order to achieve a particularly good homogenization of the filler material filled in the functional opening—for example, for a particularly homogenous light distribution.

In the further development of the method, the seal element is the cutting-aid layer. In other words, the seal element is fixed against the visible side of the decoration blank by the applying of the cutting-aid layer onto the decoration blank, since the cutting-aid layer and the seal element are identical. Thus in a particularly resource-saving manner the cutting-aid layer has a dual functionality, and a providing of a seal element formed separately from the cutting-aid layer can advantageously be omitted.

Of course it is just as easily conceivable to provide the seal element as a layer in addition to the cutting-aid layer. This additional cutting-aid layer can then be adhered directly onto the visible side of the decoration blank, for which the cutting-aid layer is first removed.

In the method according to a further example, it can be provided that the cutting, in particular laser cutting, is composed of a plurality of cutting operations that are carried out successively or at least partially temporally overlapping one another. It is conceivable, for example, that the cutting machine includes more than one cutting element that are used simultaneously or successively along the functional opening contour. In the case of the laser cutting machine, it can be provided that it simultaneously emits two, three, or more laser beams that successively or at least in part simultaneously process or cut the composite. For example, for this purpose each of the cutting elements or each of the laser beams is associated with one of the cutting operations.

In other words: for the cutting-through of the decoration blank a multi-step cutting process, in particular laser-cutting process, can be used. Using the laser-cutting machine, a region to be cut can be—in particular without removing the composite or the decoration blank from the processing region between partial processes of the cutting, or repositioning it in the processing region—traversed multiple times or successively using identical or different settings of the laser-cutting machine. Thus the individual cutting operations and/or the individual cutting regions can be traversed using common, overlapping, and/or different trajectories or by trajectory repetitions. Here the same or different settings can be used, such as laser power, laser focus, feed speed, laser pulse size, laser cutter operating mode (sustained laser, intermittent laser, trepanning, percussion, etc.) and/or further laser setting parameters influencing the cutting.

In particular, in a first cutting operation a first of the layers of the composite can first be cut-into, and cut-through in a second cutting operation subsequent to the first cutting operation. It is likewise conceivable that in the first cutting operation a first of the layers of the composite is cut-into or cut-through, and in the second cutting operation at least one other of the layers of the composite is cut-into or cut through. It can furthermore be provided that all layers of the composite are cut-through by the laser cutting in a common cutting operation.

The decorative element is provided for a motor vehicle, in particular its interior. The decorative element is manufactured using a method formed according to the preceding description, and includes at least one functional opening. In the intended installation position, that is, when the decorative element has been inserted as intended in the interior of the motor vehicle, the visible side of the decoration blank faces into the interior of the motor vehicle so that an occupant of the motor vehicle sees the visible side upon observing the decoration blank. Here the adhesive side of the application material layer faces toward the interior of the motor vehicle, while the adhesive side of the decoration blank faces away from the interior. The adhesive side of the decoration blank and the adhesive side of the application material layer are facing each other and adhered with each other.

In particular, the decorative element is part of an interior illumination system. For this purpose the decorative element then includes at least one functional opening that is configured as light opening. In this case the motor vehicle includes a light source from which in an activated state visible light is decoupled. Here the light source and the decorative element are oriented with respect to each other, or directly or indirectly (for example, using a light conducting device) connected to each other in a light conducting manner such that light decoupled from the light source filters-through through the light opening(s), in particular through the respective filler material, and in this way radiates into the interior of the motor vehicle. Due to the (in particular milky) translucence of the decorative element, at least in the region of the light opening, a diffuse illumination pattern advantageously results, which, for example, can be efficiently used for ambient lighting purposes.

Light source includes one illuminant or more illuminants and is in particular configured to radiate a so-called RGB illumination. Accordingly the light source is in particular an RGB light source. Examples for the respective illuminants, that can form the light source individually or at least groupwise, are: An incandescent lamp, glow lamp, and/or gas discharge lamp. A light-emitting diode (LED), in particular an organic LED (OLED). An LED chain or an LED band. An (in particular light-conducting) textile and/or film structure, in which one or more illuminants is/are incorporated. In particular this textile structure can be the application material layer that includes the illuminant or the illuminants in the functional opening region.

The light-conducting device includes one light-conducting element or more light-conducting elements, for example, an LED band or an LED chain. Examples for the respective light-conducting element that can at least partially form the light-conducing device individually or at least groupwise with each other, are: A flat light conductor, for example, made of polycarbonate, made of poly(methyl methacrylate) or from another plastic suitable for conducting light. A plurality of illuminants of the light source (in one example a plurality of LEDs) are arranged laterally on narrow sides of the flat light conductor. The light is, for example, introduced in a lateral plate or in a dimensionally stable injection-molded lamination carrier. A light-conducting cord, in which the generated light is introduced via a coupled illuminant (in one example an LED). A flat textile, in which light-conducing threads are introduced. This lies between the carrier structure and the decorative element laminated onto it. A textile and/or film structure in which one light-conducting element or more light conducting elements is/are incorporated. In particular this textile structure can be the application material layer that includes the illuminant or illuminants and/or one or more of the light-conducting elements at least in the functional opening region.

Alternatively or additionally the decorative element can be part of a loudspeaker system in the interior of the motor vehicle, for example, be disposed as cover over a loudspeaker. For this purpose the decorative element then includes at least one sound opening.

The light source can be part of an electric or electronic assembly that includes the light source, in particular at least one illuminant and/or at least one light-conducting element. Furthermore, the electric/electronic assembly can include a circuit that can be formed from electric conductor elements (such as cables, wires, conductive jacketed filaments, printed conducting paths, etc.) as well as a voltage source for the supplying of energy to the light source. In addition the assembly can include a control unit, in particular in order to control the light source such that a particular light effect or a plurality of different light effects can be generated. Such a light effect is, for example, regularly or irregularly recurring illuminating and/or blinking of the light source, that is, its illuminant. Thus, for example, a so-called running light can be realized. At least one component of the electric/electronic assembly is, in one example formed particularly small; for example, an LED carrier can be formed in the shape of a sewable sequin.

The electric or electronic assembly can, for example, be sewed-on onto the application material layer. Here the application material layer can serve as a light reflector or light diffusor. The filler material itself, with which the corresponding gap or the application material layer is filled, can furthermore likewise function as light conductor/light diffusor. This means the filler material can alternatively or in addition to the electronic or electric assembly be backlit or illuminated by a further light source. Particularly striking light effects can thereby be generated by a light effect generated by the electronic or electric assembly and a further light effect generated by the further light source overlapping, or regularly or irregularly alternating. Here one of the light effects can be a static illumination.

At least illuminants of the electric/electronic assembly—i.e., in particular LEDs—can be directly (under the through-opening or functional opening to be filled) or indirectly (near the through-opening or functional opening to be filled) positionally fixed by the filler material. The respective LED can be completely or partially embedded in the functional opening. It can be provided that its LED surface terminates flush with the visible side of the decoration blank. A sacrificial layer already described above-namely the cutting-aid layer functioning in this case as the seal element—can be used during the filling of the respective through-opening, in which the electric and/or electronic assembly is at least partially disposed, to seal the LED surface flush with the visible side, so that no filler material reaches the LED surface.

The application material layer can furthermore serve as spacer or positioning aid for the orienting of the LED with respect to the functional opening and/or with respect to the visible side of the decoration blank. The through-opening is, for example, overspanned with the application material layer, or the application material layer is deformed, at least in a deformation region, such that it has loops, wrinkles, nubs, etc. The electronic or electric assembly is at least partially attached at the deformation region, that is, at the loops, wrinkles, and/or nubs. The deformation region at least partially including the electric/electronic assembly is then placed in the functional openings. The through-opening of the application material layer and/or the through-opening of the decoration blank serve/serves here as (respective) positioning- and fixing-aid of the application material layer (on which deformations and/or separate spacers are disposed, for example, grids, treads, etc.) Alternatively spacing- or positioning-aids made of a separate material can be applied onto the application material layer.

A further possibility to equip the application material layer with the electric and/or electronic assembly includes attaching at least a portion of each assembly—in particular, the light source or the illuminant/illuminants, for example, the LED/LEDs—or the entire assembly onto the rear side of the application material layer. In any case, the illuminant disposed on the rear side of the application material layer is not visible for the viewer when it is not switched into a lighting operation. The application material layer covering the illuminant functions in this case as light-scattering element or light diffusor.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a schematic view of a decoration blank, of an adhesive layer and of an application material layer, which are provided in a method for the manufacturing of a decorative element according to the present disclosure;

FIG. 2 is a schematic view of a cutting machine, in the present case a laser cutting machine, in which a composite (shown in sectional view) made of the decoration blank, an assistive adhesive layer, and a cutting-aid layer is clamped according to the present disclosure;

FIG. 3 is a schematic view of a part of the composite, wherein the decoration blank and the application material layer are adhered with each other by the adhesive layer according to the present disclosure;

FIG. 4 is a schematic view of the composite, wherein the cutting-aid layer is non-destructively released from the visible side of the decoration blank according to the present disclosure;

FIG. 5 is a schematic view of the composite that has been processed using the laser cutting machine, in which a functional opening is filled in with a filler material that flows through the application material layer according to the present disclosure;

FIG. 6 is a schematic view of the composite that has been processed using the laser-cutting machine, wherein a functional opening is filled with a filler material that flows-in into the functional opening through an opening cut into the application material layer by the laser-cutting machine according to the present disclosure;

FIG. 7 is a schematic sectional view of the decorative element that has been produced using the method and includes functional openings according to the present disclosure; and

FIG. 8 is a schematic view of the decorative element, in which the decoration blank is composed of two decoration blank parts according to the present disclosure;

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

Identical and functionally identical elements are provided in the Figures with identical reference numbers. In the following a method for the manufacturing of a decorative element 1 (see FIG. 8) and the decorative element 1 itself shall be presented in a common description. It generally applies that when one feature or more features of a functional opening 19, 40, 41, 42, 43, 47, 49, 50 introduced further below are described herein, the corresponding feature or the corresponding features can correspondingly be applied to the other of the functional openings 19, 40, 41, 42, 43, 47, 49, 50.

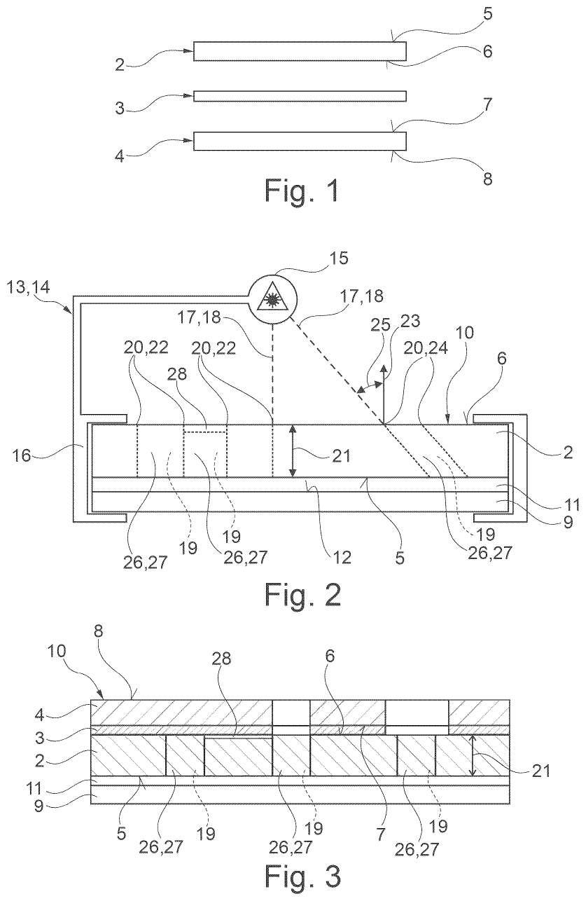

For this purpose FIG. 1 shows in schematic view a decoration blank 2, an adhesive layer 3, and an application material layer 4 that are provided in a first step of the method for the manufacturing of a decorative element 1. Merely by way of example the decoration blank 2 is formed from a leather or leather-like material and thus flexible or pliable. The decoration blank 2 includes a visible side 5 and an adhesive side 6 that are opposite each other and spaced by a material thickness of the decoration blank 2. In the present example, the application material layer 4 is formed from a textile and flexible or pliable, in particular to a similar or the same degree as the decoration blank 2. Furthermore, the application material layer 4 is permeable for light that is visible by a person with physiological eyes without further aid. This means that the application material layer 4 is permeable for light that has a wavelength of approximately 380 nm (nanometers) to approximately 780 nm. the application material layer 4 includes an adhesive side 7 and a lamination side 8 that are opposite each other and spaced from each other by a material thickness of the application material layer 4.

In a further step of the method, the decoration blank 2 and a cutting-aid layer 9 are adhered with each other into composite 10, wherein in the present example an assistive adhesive layer 11 is inserted between the cutting-aid layer 9 and the decoration blank 2. The assistive adhesive layer 11 can be a component of the cutting-aid layer 9. In the composite 10, the visible side 5 of the decorative element 1 and an adhesive side 12 of the cutting-aid layer 9 are facing each other, and optionally spaced from each other by a thickness of the assistive adhesive layer 11. For the method the decoration blank 2 and the cutting-aid layer 9 are thus temporarily connected with each other in a material-bonded manner. Here the decoration blank 2, and/or the assistive adhesive layer 11, and/or the cutting-aid layer 9 are/is configured such that the material-bonded connection between the decoration blank 2 and the cutting-aid layer 9 is intentionally non-destructively releasable. Thus the cutting-aid layer 9 that has been adhered onto the visible side 5 of the decoration blank 2 to form the composite 10, is releasable or removable again from the visible side 5 without the visible side 5 of the decoration blank 2 being damaged during the releasing. In other words: The cutting-aid layer 9 is non-destructively removable from the visible side 5.

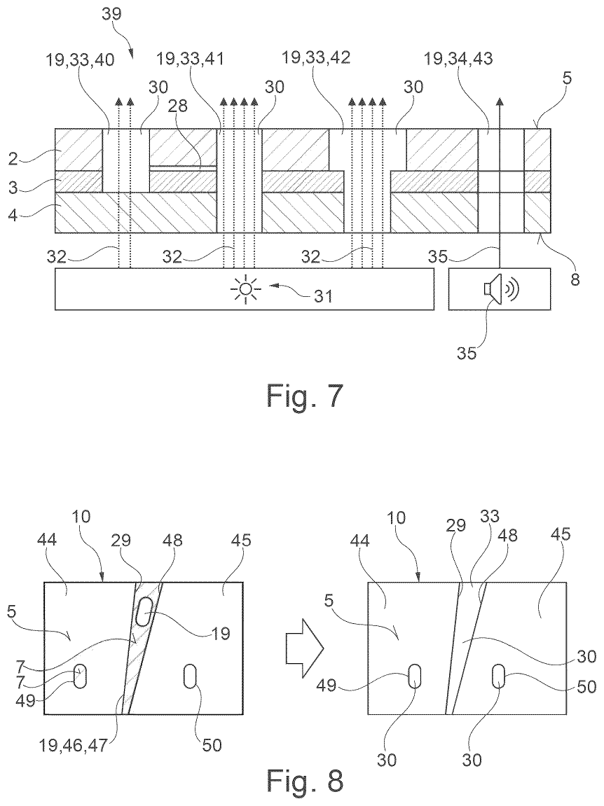

In a further method step, the composite 10 is positioned in a processing region of a cutting machine 13 and fixed there, wherein in the present example the cutting machine 13 is configured as a laser-cutting machine 14. Here the composite 10 is clamped into the laser-cutting machine 14 such that the adhesive side of the decoration blank 2 and a laser-emitter unit 15 of the laser-cutting machine 14 are facing each other, while the visible side 5 of the decoration blank 2 faces away from the laser-emitter unit 15. Accordingly FIG. 2 shows a schematic view of the laser-cutting machine 14 that includes a clamping device 16 in which the composite 10 (depicted in cut view) is clamped. The clamping device 16 and the laser-emitting device 15 can be movable relative to each other, so that in a cutting operation of the laser-cutting machine 14 the laser-emitter unit can be moved with respect to the composite 10. The laser-cutting machine 14 includes-like every other cutting machine 13 as well-α cutting element 17 that includes one laser beam 18 or more laser beams 18 which, in a cutting operation of the laser-cutting machine 14, are sent from the laser-emitter unit 15 toward the clamped-in composite 10, and in particular into the clamped-in composite 10. Here the laser-cutting machine 14, which in the present case is a computer-controllable laser-cutting machine, i.e., for example, a CNC laser-cutting machine, is configured to cut-in one functional opening 19 or more functional openings 19 (first shown in FIG. 7) into the composite 10.

In a first step of the method, a processing is then affected of the composite 10 using the laser-cutting machine 14 in order to form the respective functional opening 19. Here at least the decoration blank 2 is cut-through along a prescribed or prescribable functional opening contour 20 using the laser-cutting machine 14. The cutting-through of at least the decoration blank 2 is thus affected by laser cutting. As can further be seen from FIG. 2, the cutting element 17 of the cutting machine 13, i.e., here the laser beam 18 of the laser-cutting machine 14, impinges for through-cutting of the decoration blank 2 onto its adhesive side 6 and cuts-in or cuts-through the composite 10 toward the adhesive side 12 of the cutting-aid layer 9 down to a prescribed or prescribable cutting depth 20. Here the laser beam 18 impinges or at least some of the laser beams 18 impinge—for example, in a first functional opening contour section 22—perpendicularly on the adhesive side 6, i.e., parallel to a surface normal 23 of the adhesive side 6. Additionally or alternatively, the laser beam 18 impinges or at least some of the laser beams 18 impinge—for example, in a second functional opening contour section 24—obliquely onto the adhesive side 6. In this case the corresponding laser beam 18 and the surface normal 23 enclose an angle 25 with each other that is greater than 0° and less than 90°. It can be provided here that one and the same functional opening 19 includes both at least one first functional opening contour section 22 and at least one second functional opening contour section 24.

Due to the cutting of the decoration blank 2, a one- or multi-part waste piece 26 results that is removed from the composite 10, for example, by the waste piece 26 being pulled off of the composite. By the removing of the correspondingly associated waste piece 26, the functional opening 19 is formed. The functional opening 19 can thus, for example, be formed by the decoration blank 2 being cut-through by the laser-cutting machine 14 along the corresponding functional opening contour 20 and then the waste piece 26 that includes at least one decoration material portion 27 being removed from the composite 10.

In the present case, in the course of processing the composite, i.e., during the cutting of the functional openings 19 into the decoration blank 2, at least one channel element 28 is formed on the adhesive side 6 of the decoration blank 2. Here the channel element 28 is positioned or disposed on/in the adhesive side 6 of the decoration blank 2 such that using the channel element 28 at least two functional openings 19, or at least one functional opening 19 and one edge 29 (see FIG. 8) are fluidically connected with each other. During the forming of the respective channel element 28, the visible side 5 of the decoration blank 2 is not damaged. That is, for the forming of the channel element 28, the cutting element 17 only penetrates far enough into the decoration blank 2 that specifically the channel element 28 is formed, but the visible side 5 is not damaged here.

It is to be understood that the decorative element 1 can include more than one functional opening 19 and more than one channel element 28. In other words, it can be provided that during the manufacturing of the decorative element 1, more than one functional opening 19 or more than one channel element 28 are/is cut-in into the composite 10. Here the functional openings 19 and/or the channel elements 28 are configured identically to or different from one another.

In a further step of the method, the decoration blank 2 and the application material layer 4 are adhered with each other by the adhesive layer 3. For this purpose FIG. 3 shows a schematic view of the composite 10, wherein the decoration blank 2 and the application material layer 4 are adhered with each other by the adhesive layer 3. The adhesive layer 3 or an adhesive forming the adhesive layer 3 is brought between the decoration blank 2 and the application material layer 4, in which the adhesive sides 6, 7 respectively of the adhesive layer 3 or the adhesive are facing each other. It can be provided that the adhesive is applied onto the adhesive side 6 and/or onto the adhesive side 7, and then the adhesive sides 6, 7 are moved toward each other until the adhesive applications together form the adhesive layer 3 between the decoration blank 2 and the application material layer 4. Consequently the decoration blank 2 and the application material layer 4 are connected with each other in a material-bonded manner.

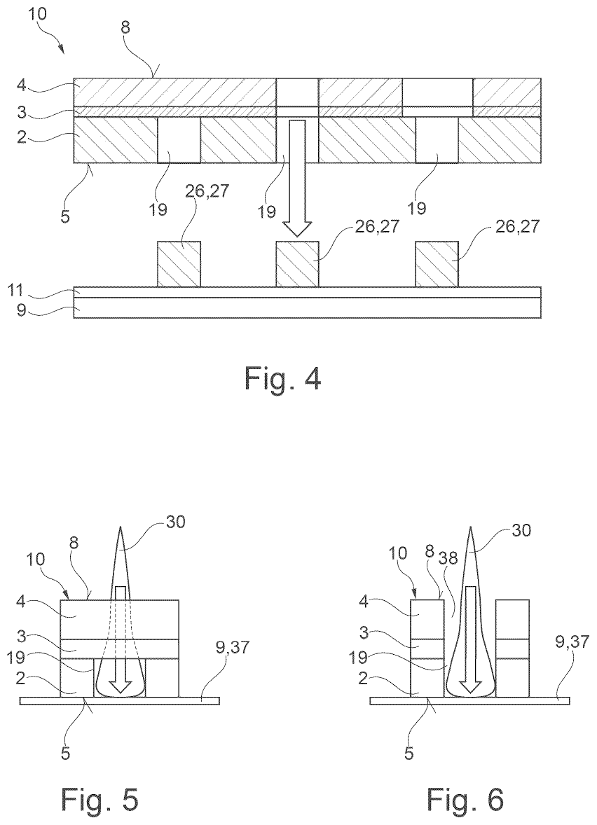

From FIG. 3 and FIG. 2 it can furthermore be seen that in the present example the cutting depth 21 is prescribed such that the cutting element 17 or the laser beam 18 cuts-in into the composite 10 at most deep enough that specifically the decoration blank 2 is completely cut-through, but the cutting-aid layer 9 is not completely cut through. Before or after the adhering of the decoration blank 2 with the application material layer 4, the waste piece 26 is then removed by it being removed out of/from the composite 10, i.e., out of/from the decoration blank 2. Since the waste piece 26 and the cutting-aid layer 9 are adhered with each other, in the present example it is provided that the removing of the waste piece 26 is affected by the cutting-aid layer 9 being removed or released from the composite 10, i.e., from the visible side 5 of the decoration blank 2. For this purpose FIG. 4 shows a schematic view of the composite 10, wherein the cutting-aid layer 9 is non-destructively removed from the visible side 5 of the decoration blank 2, whereby the waste piece 26 adhered with the cutting-aid layer 9 is also removed from the composite 10. Due to the removing of the respective waste piece from the composite 10, the respective functional opening 19 is exposed.

In a further step of the method at least one of the functional openings 19 is completely or partially filled or filled in with a filler material 30 (see FIG. 5 and FIG. 6). In its cured state the filler material 30 is translucent, that is, permeable for visible light, or transparent, in particular transparent with image fidelity. If the completed decorative element 1 is illuminated with visible light 32 by an illuminant 31 (see FIG. 7) on the side of the lamination side 8, the light 32 then enters into the filler material 30 and exits from the decorative element 1 on the side of the visible side 5. In addition, during the filling of the functional opening 12 with the filler material 30, the lamination side is at least partially coated, wetted, and/or soaked. This favors a light entry into the corresponding functional opening 19. In order to achieve a diffuse light distribution or light appearance at the visible side 5, in the present example it is provided that the filler mate-rial 30 is milky in the cured state. By the corresponding functional openings 19 being filled with the filler material 30, a light opening 33 (see FIG. 7) is at least partially formed from the functional opening 19.

The functional opening 19 or another of the functional openings 19 can furthermore at least partially be a flow-permeable and/or sound permeable opening, in the present case a sound opening 34 (see FIG. 7). In this case, the decorative element 1 can function as a cover element for a loudspeaker 35, in which sound waves 36 generated by the loudspeaker 35 then move through the sound opening 34. Because the sound opening 34 or a sound opening region of the corresponding functional opening 19 is not filled with the filler material 30 or kept free of the filler material 30 during filling of the light opening 33 or of a light-opening region of the corresponding functional opening 19. Alternatively the sound opening 34 or the sound-opening region can be produced by the filler material 30 being removed again at least partially from the corresponding functional opening 19 after the filling.

FIG. 5 and FIG. 6 each show a schematic view of the composite 10, in which the functional opening 19 is filled with the filler material 30. For the filling of the functional opening 19 with the filler material 30, the filler material 30 is brought at least into a pasty, in the present case at least approximately liquid state, or is already provided in this state. This causes that during the filling of the functional opening 19 that is thereby at least partially formed as for light opening 33, a material-bonded connection is produced at least between the decoration blank 2 and the filler material 30. The composite 10 is thereby stabilized or strengthened by the filling with the filler material 30. For this purpose the filler material 30 has adhesive properties of an adhesive or is an adhesive. After the curing of the filler material 30, no regions abut against the visible side 5, that is, against the visible side of the decorative element 1 or on its rear side (i.e., against the lamination side 8 of the application material layer 4) at which a user of the decorative element 1, for example, a fitter, who installs the decorative element 1, remains stuck in an unintended manner. Instead, a particularly favorable, in particular haptically pleasant surface results, even in regions in which a part of the outer surface of the decorative element 1 is formed by the filler material 30.

In order to inhibit that the visible side 5 of the decoration blank 2 or of the decorative element 1 is soiled in an undesired manner by filler material 30 escaping from the functional opening 19, in the present case the visible side 5 of the decoration blank 2 including the light opening 33 and a seal element 37 are fixed against each other for the filling of the functional opening 19 or light opening 33, whereby the light opening 33, or the functional opening 19 which is formed for the light opening 33, is sealed against fluids on the visible side 5. It is thereby inhibited that filler material 30 escapes from the light opening 33 or functional opening 19 onto the visible side. The cutting-aid layer 9 is used with particular efficiency and versatility when it is used as the seal element 37. In other words, the seal element is provided by the identical cutting-aid layer 9 being provided. With the applying of the cutting-aid layer 9 on the visible side 5 of the decoration blank 2, the seal element is thus fixed on the decoration blank 2.

FIG. 5 shows a schematic view of the composite 10 that has been processed by the laser-cutting machine 14, in which the functional opening 19 is filled in with the filler material 30 that flows through the application material layer 4. For this purpose—when in the region of the functional opening 19 to be filled, the adhesive layer 3 is left out—the application material layer 4 is provided fluid-permeable. The filler material 30 is then contacted directly with the lamination side 8 of the application material layer 4, so that the at least approximately liquid filler material 30 can penetrate into the application material layer 4. With a steady inflow of filler material 30 toward the lamination side 8, the application material layer 4 is saturated with filler material 30 until the application material layer 4 is supersaturated in the region of the functional opening 19 to be filled. Due to the supersaturation, the filler material 30 flows out onto the adhesive side 7 from the application material layer 4, and consequently into the functional opening 19. The filler material 30 is thus introduced from the lamination side 8 of the application material layer 4 into the corresponding functional opening 19, wherein the application material layer 4 is flowed-through by the filler material 30 toward the visible side 5 of the decoration blank 2, whereby the filler material 30 flows-in into the functional opening 19.

When in the region of the functional opening 19 to be filled the adhesive layer 3 was not left out, under the constant inflow onto the lamination side 8 the filler material 30 supersaturates and flows-through first the application material layer 4 and then the adhesive layer 3. Due to the supersaturation the filler material 30 flows out onto the adhesive side 7 out of the application material layer 4, and consequently into the adhesive layer 3. With a flowing-out from the adhesive layer 3, the filler material 30 then flows into the functional opening 19.

In any case the filler material 30 is introduced from the lamination side 8 of the application material layer 4 into the corresponding functional opening 19, wherein the application material layer 4 is flowed-through by the filler material 30 toward the visible side 5 of the decoration blank 2, whereby the filler material 30 flows-in into the functional opening 19. For this purpose the application material layer 4 and possibly the adhesive layer 3 are provided fluid-permeable—that is, at least permeable for the filler material 30 when it is in the liquid, approximately liquid, or pasty state. For the adhesive layer 3, this means that the adhesive layer 3 or the adhesive forming the adhesive layer 3 is permeable in the cured state for the filler material 30 in the liquid, approximately liquid, or pasty state.

In FIG. 6 an alternative is shown in order to guide the filler material 30 in to the functional opening 19. FIG. 6 shows a schematic view of the composite 10 that has been processed using the laser-cutting machine 14, in which the functional opening 19 is filled in with the filler material 30 that flows in through an opening 38, formed application material layer 4, into the functional opening 19. Consequently in this case during the providing of the application material layer 4, the opening 38 is provided that corresponds with the corresponding functional opening 19. It can furthermore be provided that the opening 38 is cut-in into the application material layer 4 using the laser-cutting machine 14. This can occur before the adhering of the application material layer 4 with the decoration blank 2, or when the application material layer 4 has already been adhered with the decoration blank 2.

Since in the present example the at least one channel element is formed during filling of the functional opening 19 with the filler material 30, the channel element 28 is filled with the filler material 30, whereby the at least two elements, fluidically connected by the channel element 28, of the decoration blank 2 are connected to each other in a material-bonded manner by the filler material 30. If the channel element 28 thus connects, for example, two functional openings with each other, the filler material 30 flows into the two functional openings 19 as well as into the channel element 28 or through the channel element 28. Thus the two functional openings 19 connected with each other by the channel element 28 are connected with each other in a material-bonded manner by a filler-material bridge. Here the filler-material bridge extends in a materially bonded manner from the one of the functional openings 19, through the channel element 28, up to another of the two functional openings 19.

FIG. 7 shows a schematic and cut view of the decorative element 1 that has been manufactured using the method and includes functional openings 19. The decorative element 1 is pro-vided for an interior 39 of a motor vehicle (not shown). In the intended installation position of the decorative element 1 it forms a component of the motor vehicle. The decorative element 1 is in particular an interior element, i.e., for example, a cover element for the loudspeaker 35, a door panel, a central console, an instrument panel, etc., or another cladding- and/or cover-element. Here the visible side 5 of the decorative element 1, that is, the visible side 5 of the decoration blank 2 faces into the interior 39, while the lamination side 8 of the decorative element 1, that is, the lamination side 8 of the application material layer 4, faces out of the interior 39.

In FIG. 7 it is also to be noted that the decorative element 1 includes more than one functional opening 19—in the present case four functional openings 19. Here a first functional opening 40, a second functional opening 41, and a third functional opening 42 are each configured as a light opening 33, wherein a fourth functional opening 43 is configured as a sound opening 34. On the example of the third functional opening 42, it is to be noted that the respective functional opening 19 can have different geometries, diameters, etc. along the material thickness of the composite 10 or of the decorative element 1.

FIG. 8 shows a schematic view of the decorative element 1, in which during the manufacturing of the decorative element 1 the decoration blank 2 is composed of at least two decoration blank parts 44, 45. The decoration blank parts 44, 45 are initially provided separate from each other and then, with the forming of at least one edge opening 46 or edge gap between them, adhered with the application material layer 4. A further functional opening 47 is thus formed by the edge opening 46. It can be provided that, prior to the connecting of the decoration blank 2 with the application material layer 4, the edge gap or the edge opening 46 is cut by at least one cut using the laser-cutting machine 14, for example, in order to respectively straighten the mutually opposing edges 29, 48. For this purpose the decoration blank parts 44, 45 can be connected with the cutting-aid layer 9 for positional securing. Furthermore, it can be provided that inside a material-free space, by which the mutually facing edges 29, 48 are spaced from each other, a (further) functional opening 19 is cut-in into the composite 10 by the application material layer 4 being cut-through at the corresponding location using the cutting machine. In this case the waste piece 25 is free of decoration material. The edge opening 46 can be filled or filled in with the filler material 30 when a light opening 33 is to be formed by the edge opening 46.

Since the decoration blank parts 44, 45—and possibly at least one further decoration blank part (not shown)—together form the decoration blank 2, it is clear that one or more of the decoration blank parts, for example, one or both of the decoration blank parts 44, 45, can include one of the functional openings 19. This is shown in FIG. 8 by the functional openings indicated with 49, 50. Here the functional opening 49 is formed by the decoration material of the decoration blank part 44 having been completely cut-through before the decoration blank 2 and the application material layer 4 have been joined into the composite 10. The functional opening 50 was generated by both the material of the decoration blank part 45 and the application material layer 4 having been completely cut-through in the respective region, whereby the associated waste piece 26 then includes decoration material of the decoration blank part 45 and material of the application material layer 4. It is also conceivable for the functional opening 50 that—before the decoration blank 2 and the application material layer 4 have been joined into the composite 10—a first waste piece 26, which is free from material of the application material layer 4, is cut-out from the decoration blank 2, then the decoration blank part 45 and the application material layer 4 are connected with each other, and then from the application material layer 4 a corresponding waste piece 26 is cut-out that is free from material of the decoration blank part 45. Of course, it is equally possible to process the application material layer 4 and the decoration blank part 45 separately from each other using the cutting machine, in order to cut-out two separate waste pieces 26, in which one is free from material of the application material layer 4, and the other is free from material of the decoration blank part 45. Then the decoration blank part 45 and the application material layer 4 are connected with each other.

In general, the design possibilities in the decorative element 1 or in the manufacturing of the decorative element 1 using the method described herein are unlimited—it is, for example, made possible, after the removing of the waste piece 26 that is comprised at least partially of the material of the decoration blank 2, to insert an insert piece (not shown) made of the decoration material or a different material, in particular a different decoration material, at the location of the waste piece 26, that is, in the opening that has been cut into the decoration blank 2. This means that an insert piece can be inserted in one or more of the functional openings 19, 40, 41, 42, 43, 47. Furthermore, two or more insert pieces can be used and each inserted in one or more of the functional openings 19, 40, 41, 42, 43, 47. Here the respective insert piece can be a different color, differently structured, or have different surface properties, and/or of a different design/geometry than the cut-out waste piece 26 or than the surrounding decoration material. For example, a circular-disk-shaped (or shaped according to any other geometrically closed curve) portion can be cut out from the decoration blank 2 and removed. The insert piece can also be shaped according to a geometrically closed curve, for example, formed oval, star-shaped, serrated, etc. In addition, the insert piece have different light-transmission properties than the cut-out waste piece 26 or the surrounding decoration material. It can be, for example, less or more transparent.

In order to provide a particularly precise in particular precisely repeatable positioning of the insert piece, it can also be provided that—explained on the basis of circular shapes merely by way of example—first two (in particular concentric) circles are cut-in into the decoration material so that a circular ring and an inner circle remain as waste piece 26. Then the inner circle is removed from the composite 10 or from the decoration blank 2, wherein the circular ring initially remains on the composite 10 or on the decoration blank 2. In the now free inner region of the circular ring, the insert piece is then appropriately inserted, wherein an outer contour of the insert piece and an inner contour of the circular ring correspond with each other. The circular ring cut free thus functions as positioning aide for the positionally precise inserting of the insert piece. In order to then fill the functional opening 19 with the filler material 30, the circular ring is removed from the composite 10 or from the decoration blank 2.

Furthermore, as insert piece can include an electrical or electronic component, or be formed from the electronic or electric component. The electrical or electronic component is, for example, a sensor, a control, an illuminant, a light-guide element, etc. Such an electric or electronic com-ponent can alternatively or additionally—in particular prior to the filling of the functional opening 19—be inserted into the functional opening 19 so that the functional opening 19 serves as receptacle for the electronic or electric component. This sits particularly securely in the functional opening 19 by it being molded in the filler material 30.

The insert piece can furthermore be a grid- or frame-forming structure, for example, as ventilation grille.

By the method for the manufacturing of the decorative element 1 as well as by the decorative element 1 itself, possibilities are shown how the decorative element 1 is providable with at least one functional opening 19. Here the decorative element 1—despite the functional opening(s) 19—is laminatable particularly simply and efficiently with high lamination quality onto a carrier structure (not shown) and particularly stable and durable.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

In this application, the term “controller” and/or “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components (e.g., op amp circuit integrator as part of the heat flux data module) that provide the described functionality; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A method for manufacturing a decorative element, including a functional opening, for a motor vehicle, the method comprising:
providing a decoration blank that includes a visible side and an adhesive side, and an application material layer that includes an adhesive side and a lamination side;
cutting through the decoration blank along a functional opening contour using a cutting element of a cutting machine to form a waste piece, and removing the waste piece to form the functional opening;
before or after the cutting through of the decoration blank: applying the adhesive side of the application material layer onto the decoration blank, and the adhesive side of the decoration blank and the adhesive side of the application material layer being adhered with each other by an adhesive layer; and
filling the functional opening with a filler material that reacts into a cured state, in which it is at least partially translucent, at least partially transparent, completely transparent, or is light-impermeable.

2. The method according to claim 1,
wherein before the cutting through of the decoration blank, a cutting aid layer is applied onto the visible side of the decoration blank, and the cutting aid layer is non-destructively releasable from the visible side.

3. The method according to claim 2,
wherein for the cutting through of the decoration blank, a cutting depth is predetermined such that the cutting element cuts through the decoration blank completely, but the cutting aid layer is not completely cut through.

4. The method according to claim 2,
wherein the cutting aid layer is non-destructively released from the visible side of the decoration blank, and the waste piece resulting from the cutting through of the decoration blank that is adhered to the cutting aid layer is removed.

5. The method according to claim 1,
wherein the cutting through of the decoration blank is performed by laser cutting.

6. The method according to claim 5,
wherein the laser cutting includes a plurality of cutting operations that are carried out successively or at least partially temporally overlapping one another.

7. The method according to claim 1,
wherein for the cutting through of the decoration blank, the cutting element impinges onto the adhesive side thereof, and cuts in toward the visible side of the decoration blank, so that the decoration blank is completely cut through.

8. The method according to claim 1,
wherein in a first functional opening contour section the cutting element impinges onto the adhesive side of the decoration blank parallel to a surface normal of the adhesive side.

9. The method according to claim 8,
wherein in a second functional opening contour section the cutting element impinges onto the adhesive side of the decoration blank obliquely to a surface normal of the adhesive side.

10. The method according to claim 8,
further comprising generating a second functional opening that forms at least one of a flow-permeable or a sound-permeable opening by the decoration blank being cut through by the cutting element along a second functional opening contour to form the waste piece, and the waste piece being removed, wherein during the filling of the functional opening with the filler material, at least one of the flow-permeable and the sound-permeable opening is at most partially filled with the filler material.

11. The method according to claim 1,
wherein the decoration blank is formed from two mutually separate decoration blank parts that are adhered together with the application material layer, an edge opening is formed between the mutually separate decoration blank parts, and a second functional opening is formed by the edge opening.

12. The method according to claim 1,
wherein on the adhesive side of the decoration blank, a narrow channel element is formed by the material of the decoration blank being removed from the adhesive side of the decoration blank, without damaging the visible side, and with the forming of the narrow channel element, at least two elements of the decoration blank are fluidically connected with each other, the at least two elements include at least two of the functional opening and one or more of second functional openings,
wherein during the filling of the functional opening with the filler material, the narrow channel element is filled with the filler material, and the at least two elements, fluidically connected by the narrow channel element, of the decoration blank are connected in with each other in a material bonded manner by the filler material.

13. The method according to claim 1,
wherein the filler material for the filling of the functional opening is provided in a liquid state, and the method includes producing during the filling of the functional opening, a material-bonded connection between the decoration blank and the filler material.

14. The method according to claim 13,
wherein the application material layer and the adhesive layer are each fluid-permeable, and the method further comprises introducing the filler material from the lamination side of the application material layer into the functional opening by the adhesive layer and supersaturating the application material layer with the filler material so that the adhesive layer and the application material layer are flowed through by the filler material toward the visible side of the decoration blank, and on the adhesive side of the application material layer, the filler material exits from the adhesive side and flows in into the functional opening.

15. The method according to claim 13,
wherein for the filling of the functional opening with the filler material, the method further comprises fixing the visible side of the decoration blank including the functional opening and a seal element against each other, the seal element sealing the functional opening against fluids on the visible side and against an escape of the filler material onto the visible side.

16. The method according to claim 15,
further comprising applying a cutting aid layer onto the visible side of the decoration blank, the cutting aid layer is non-destructively releasable from the visible side and the cutting aid layer is used as the seal element.

17. The method according to claim 1,
wherein the adhesive layer and the application material layer are provided with an opening that corresponds with the functional opening, and the method comprises introducing the filler material into the functional opening through the opening.

18. A decorative element for a motor vehicle, wherein the decorative element is produced by a method according to claim 1, and includes the functional opening.
